(19) United States
(12) Patent Application Publication
(10) Pub. No.: US 2008/0295582 A1
(43) Pub. Date: Dec. 4, 2008

(54) Nondestructive Residential Inspection Method

(76) Inventors: Peng Lee, Oxford, MI (US); Kevin J. Seddon, Oxford, MI (US)

Correspondence Address: Susan B. Fentress, 6060 Poplar Ave., Suite 440, Memphis, TN, 38119, US

(21) Appl. No.: 12/194,977

(22) Filed: Aug. 20, 2008

Related U.S. Application Data
(62) Division of application No. 11/158,109, filed on Jun. 21, 2005.

(51) Int. Cl. G01N 25/56

(52) U.S. Cl. 73/74

(57) ABSTRACT

This invention relates to various methods for using a thermal imaging apparatus to inspect exterior and interior residential components. In particular these methods can be used to detect mold in residential building components.

This Application is a divisional application of U.S. Ser. No. 11/158,109 and claims priority under 35 U.S.C. Section 120 as a Continuation in Part Application of co-pending Application entitled Nondestructive Residential Inspection Method and Apparatus which was filed Mar. 11, 2004, and was assigned U.S. application Ser. No. 10/708,571, (the “571” Application), the entire disclosure of which is incorporated by reference for all that it teaches. This Application claims the benefit of U.S. Provisional Application No. 60/453,856 filed Mar. 12, 2003, under 35 U.S.C. Section 119(e) (hereby specifically incorporated by reference in its entirety).

### BACKGROUND OF INVENTION

This invention relates to the field of nondestructive residential inspection.

Infrared thermography (thermal imaging scan) has been used in industrial, electrical, mechanical and boiler evaluations. In these applications, true temperature measurements are made of the structure being evaluated. True temperature evaluations require expensive equipment and time to take temperature measurements. Additionally, infrared imaging is used for (ASTM standard #C-1153) locating wet insulation in flat roof system. Most commercial, industrial, and institutional roofs are flat roofs. However, there is no guideline or standard for pitched roofs inspection using thermal imaging. Infrared thermography has also been used to provide “energy audits” of homes (ISO 6781 and ASTM C 1090) and industrial electrical panel inspections. More specific, diagnostic applications of infrared technology for residential applications, however, require greater contrast between building components shown in the scanned images. In particular, certain types of building materials such as EFIS (Exterior Insulation & Finish System), are not easily inspected without damages to the structure.

EIFS came to the United States in 1969, imported from Europe by the Dryvit Corporation. The first uses were for commercial buildings that were similar in construction to European residential construction. After the collapse of the commercial real estate market, in an effort to maintain jobs and keep up demand, EIFS contractors descended upon the residential real estate market, and the standards, supervision and inspection protocols for installation of EIFS were all but abandoned. EIFS was adapted to American-made construction techniques, which means that the insulation and polymer coatings were being applied to “stick-built” homes. An unforeseen or ignored problem with EIFS is that improper installation can lead to moisture being trapped next to wooden construction pieces. Saturated wood that cannot dry is a perfect medium for growing mold, for attracting wood-destroying insects and for eventual rot and failure.

Traditional methods of EIFS inspection relied upon the interpretation of moisture detecting electronic meters. This process was point-to-point, that is, the inspector would have to survey an area with the surface moisture meter and then relocate to a new position and re-survey. The equipment utilized for the scan often gave false readings, so suspicious areas would have to be checked with a different moisture meter that had attached electrode probes. These probes would have to be manually inserted beneath the polymer surface and meter readings then taken of the substrate moisture content. The process was therefore time-consuming, inaccurate, inefficient, costly and limited in scope. Usually, the EIFS inspector is limited to surveys around windows and doors that are readily accessible, leaving large portions of the exterior of EIFS-clad houses out of the survey process.

### SUMMARY OF INVENTION

This invention relates to a method to inspect an exterior component of a residential building containing EIFS for moisture wherein the exterior residential building component are a wall, eave or facia. The steps of this method are: applying heat to residential building component, obtaining at least one temperature profile of the exterior residential building component and assessing the at least one temperature profile for an anomaly indicative of moisture in said exterior residential building component.

Additionally, this invention relates to a method to inspect an exterior component of a residential building (including EIFS) for moisture by elevating the interior temperature of the residence building to a degree to facilitate contrast of a at least one temperature profile; obtaining the at least one temperature profile of the exterior residential building component and assessing the at least one temperature profile for a thermal anomaly indicative of moisture, wherein the weather conditions at the time of inspection include low wind (less than one m.p.h.) wind and temperature of greater than 45° F.

This invention relates to a method to detect an electrical problem with an electrical circuit in a residential building by obtaining temperature profile. The steps of this method include: turning on substantially all light switches in the residential building; turning on substantially all exhaust blowers in the residential building; obtaining temperature profiles of substantially all electrical outlets in the residential building; and assessing each of the temperature profiles for an anomaly indicative of an electrical problem.

Finally, this invention relates to a method to locate the source of mold growth in a residential building having an interior and an exterior. This method includes the steps of: creating a temperature differential of greater than 10° F. between the interior and exterior of a residential building; obtaining at least one temperature profile of interior residential building components; assessing the least one temperature profile for a thermal anomaly indicative of moisture; and identifying the location of the thermal anomaly indicative of moisture. This method further includes the step of: sampling the location for a mold sample.

### BRIEF DESCRIPTION OF DRAWINGS

FIG. 1 is a schematic illustration of a nondestructive thermal imaging apparatus in accordance with the principles of a preferred embodiment of the invention.

FIG. 2 is a schematic illustration of a nondestructive thermal imaging apparatus in accordance with the principles of a preferred embodiment of the invention.

FIG. 3 is a schematic illustration of an alternate embodiment of the apparatus.

FIG. 4A is a visual photograph of an EIFS wall.

FIG. 4B is a temperature profile of an EIFS wall.

FIG. 5A is a temperature profile of vinyl siding.

FIG. 5B is a temperature profile of vinyl siding.

FIG. 6 is a temperature profile of an eave.

FIG. 7 is a temperature profile of an EIFS wall.

FIG. 8 is a temperature profile of a wooden wall.

FIG. 9 is a temperature profile of a brick wall.

FIG. 10A is a temperature profile of the interior surface underside of a roof.

FIG. 10B is a temperature profile of the interior surface underside of a roof.

FIG. 10C is a temperature profile of the interior surface underside of a roof.

FIG. 11 is a temperature profile of electrical component.

FIG. 12 is a temperature profile of an electrical component.

FIG. 13A is a temperature profile of an electrical component.

FIG. 13B is a temperature profile of an electrical component.

FIG. 13C is a temperature profile of an electrical component.

FIG. 13D is a temperature profile of an electrical component.

FIG. 13E is a temperature profile of an electrical component

FIG. 14A is a schematic drawing of a method to scan.

FIG. 14B is a schematic drawing of a method to scan.

FIG. 14C is a schematic drawing of a method to scan.

FIG. 15 is a temperature profile of a residential interior component.

FIG. 16 is a temperature profile of a residential interior component.

FIG. 17 is a temperature profile of a residential interior component.

FIG. 18 is a temperature profile of a residential interior component.

FIG. 19 is a temperature profile of a residential interior component.

FIG. 20A is a temperature profile of a residential interior component.

FIG. 20B is a temperature profile of an air conditioning Freon lines.

FIG. 21A is a temperature profile of a residential interior component.

FIG. 21B is a temperature profile of a residential interior component.

FIG. 21C is a temperature profile of a residential interior component.

FIG. 21D is a temperature profile of a residential interior component.

FIG. 22 is a temperature profile of a residential interior component.

FIG. 23 is a temperature profile of a residential interior component.

FIG. 24 is a temperature profile of a residential interior component.

FIG. 25 is a temperature profile of a residential interior component.

FIG. 26 is a temperature profile of a residential interior component.

FIG. 27 is a temperature profile of a residential interior component.

FIG. 28 is a temperature profile of a residential interior component.

FIG. 29 is a temperature profile of a residential interior component.

FIG. 30 is a temperature profile of a residential interior component.

FIG. 31 is a temperature profile of a residential interior component.

FIG. 32 is a temperature profile of an EFIS wall.

FIG. 33 is a temperature profile of an EFIS wall.

FIG. 34 is a temperature profile of a residential interior electrical component.

FIG. 35 is a photograph of a GFCI Breaker.

FIG. 36 is a temperature profile of a residential interior electrical breaker box component.

FIG. 37 is a photograph of a carpet.

FIG. 38 is a temperature profile of a carpet.

FIG. 39 is a photograph of a ceiling.

FIG. 40 is a temperature profile of a ceiling.

FIG. 41 is a temperature profile of a flat roof.

FIG. 42 is a photograph of a flat roof.

### DETAILED DESCRIPTION

A home inspection is a thorough visual examination of a home's structural and systemic condition. A home inspection evaluates the physical condition of the home, identifies items that may need repair or replacement and identifies systems and components that are nearing the end of their service life.

Because a home purchase is one of the biggest investments a person will ever make, a home inspection is crucial in providing valuable information about the investment. It also assists in protecting against unknown and costly repairs that may not be obvious to the untrained eye. Items covered typically include the property's wall, roof, structural components and major electrical, plumbing and operating systems.

Major areas of investigation in a home inspection include: I. Improper electrical wiring, such as open ground, hot and neutral reverse, inadequate overload protection, and hazardous wiring connections; II. Roof damage and leakage caused by old or damaged shingles and improper flashing; III. Poor overall maintenance as evidenced by such signs as cracked; makeshift wiring or plumbing; broken fixtures; IV. Structural issues, including damage to such structural components as foundation walls, floor joists, rafters and window and door headers; V. Improper surface grading and drainage problems, such as water penetration into the basement area or crawl spaces; VI. Flaws in the home's exterior, including doors, windows, door and wall surfaces, which may result in air or water penetration. In adequate caulking or weather stripping are common culprits; VII. Ventilation problems which may result in excessive interior moisture, rotting and premature failure of both structural and nonstructural elements; and VIII. Depending on location, miscellaneous concerns such as the presence of mold, wood-destroying insects, able to see signs of rodents in the ceiling.

A home inspection to be of value to a home owner needs to be complete; however, a residential inspection to be affordable must be completed within a reasonable period of time. This invention provides a method to conduct a complete inspection of a residential building within a cost effective period of time, i.e., two hours for a residential building of 2,000 sq. ft. or less, and four hours for a residential building between 3,000 to 4,000 sq. ft. The complete inspection includes several parts. One part is an infrared scan of the residential building. This type of inspection is discussed in detail, infra. Another part of a complete or “traditional” inspection is a visual inspection. A visual inspection is defined by ASHI, NAHI, and NABIE protocols. Another part of the inspection is an acoustic scan of the residential building for wood destroying insects such as termites. The procedures to conduct termite acoustic detection are set out in U.S. Pat. No. 7,271,706 filed Oct. 7, 2003, (hereby specifically incorporated by reference in its entirety—specifically, the software program at pages 28 through 42 which facilitates the acoustic detection of wood destroying insects.) A report can be generated which summarizes all portions of the inspection.

Infrared Scanning Methods and Apparatus—Infrared scanning works because different parts of a building's components retain different temperatures due to the individual component type's thermal properties, such as heat capacity, heat transmission, heat retention and heat dissipation. The difference between indoor and outdoor temperatures creates a temperature gradient, causing the heat to transmit from high temperature areas to low temperature areas. Due to the different thermal properties of different residential building components, heat transmits and dissipates through these different residential building components at different rates.

Take a building's wall in the summertime, for example: When scanning the interior wall with an infrared camera, fiber grain insulation transmits much less heat than a 2×4 stud; the 2×4 stud thus has a higher temperature which can be easily registered by the infrared sensor (camera). Infrared detection also has the advantage of covering a larger area very quickly and provides the inspector with critical information about potential problem areas in order to guide the inspector to carry out more specific tests and inspections.

Because different seasons of the year generate different weather conditions, a building experiences large fluctuations of temperature, humidity and atmospheric pressure changes. At certain times of the year, such as spring and fall, the outdoor temperature can be very close or equal to the indoor temperature. This reduction of the difference between indoor and outdoor temperatures greatly reduces the thermal imaging (infrared) device's ability to “see” inside the building's components.

The preferred procedure of the invention creates a larger temperature contrast between the building's components, thus greatly increasing the effectiveness of the thermal imaging system. The bigger the temperature contrasts between the building's components, the better the temperature profiles will be. The procedure involves activating the building's own heating or cooling system for a certain period of time prior to the inspection. The duration can be as brief as one minute to as lengthy as a few hours, depending on the size (capacity) of the heating/cooling system and the size and condition of the building. At a certain point of the heating or cooling process, the temperature contrast reaches a workable condition for the thermal imaging sensor. Therefore, the inspector will have to periodically check the conditions with the thermal camera. The decision to activate either the heating or cooling mode of the building's heating/cooling system will depend on the outdoor temperature. A preferred rule of thumb is to let the inspector make this judgment: If he feels it's cold outside (below 70° F.), he will activate the heating system. In the event that the building is not equipped with a heating or cooling system, an external heating or cooling unit can be employed to achieve a similar effect. In this method, a temperature differential of greater than 10° F. between the inside and the outside of the building is created. This can be achieved by running either the heating or air conditioning system until the desired temperature differential is obtained.

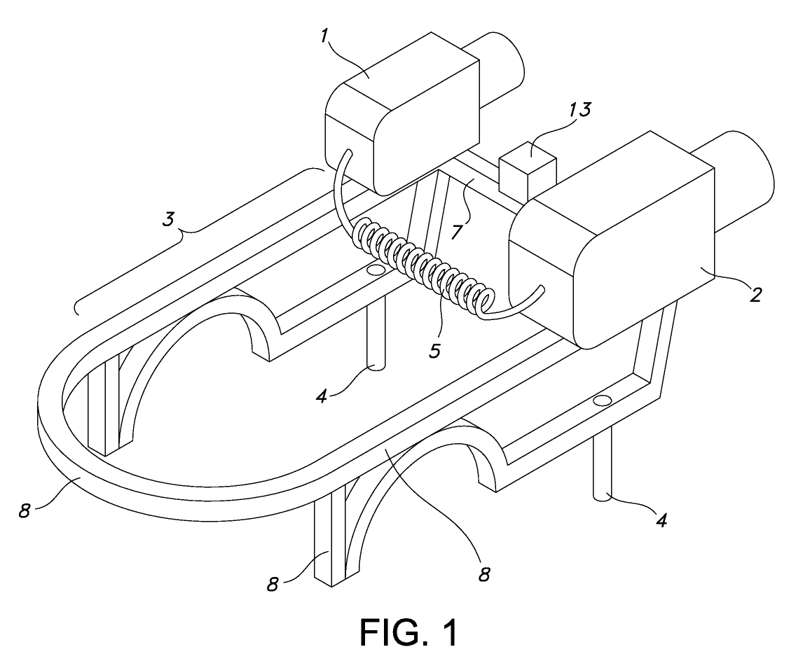

As schematically illustrated in FIG. 1, the preferred embodiment of the invention includes a thermal imaging (infrared) camera 1 for performing a scan of residential building components in order to locate potential problems in the building. An infrared camera is an apparatus that converts the spatial variations in infrared radiance from a surface into a two-dimensional image, in which variations in radiance are displayed as a range of colors or tones. In this application, it is preferred that the image is displayed as tones, with dark shades representing cold and light shades representing hot infrared radiance. This is commonly called the gray scale. Gray scale work is best for home inspection because it is less confusing; however, color is also sufficient for home inspection.

The temperature profiles created by the thermal imaging camera can be assessed to detect a thermal anomaly indicative of a problem with the residential building components. In the preferred embodiment, each of the temperature profiles is assessed for an anomaly; however, in certain situations where time is limited or a specific problem is being addressed, at least one of the thermal anomalies are assessed for a problem.

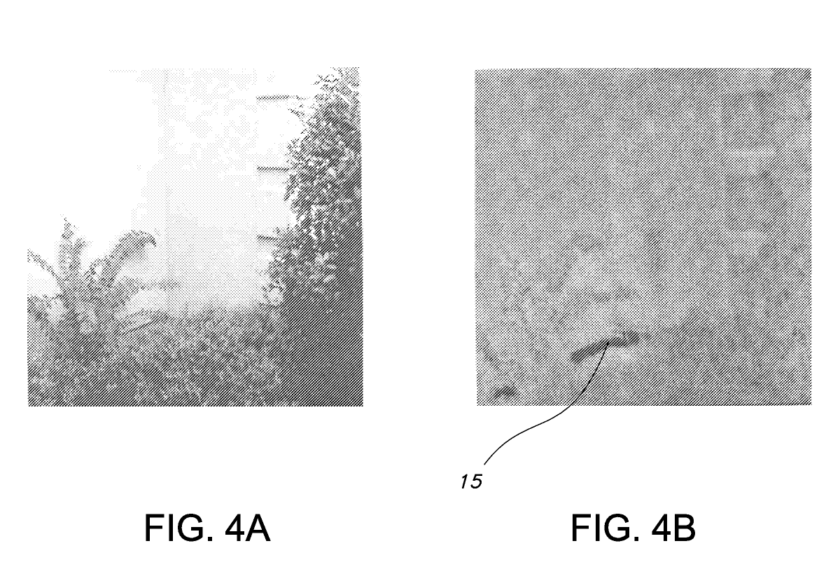

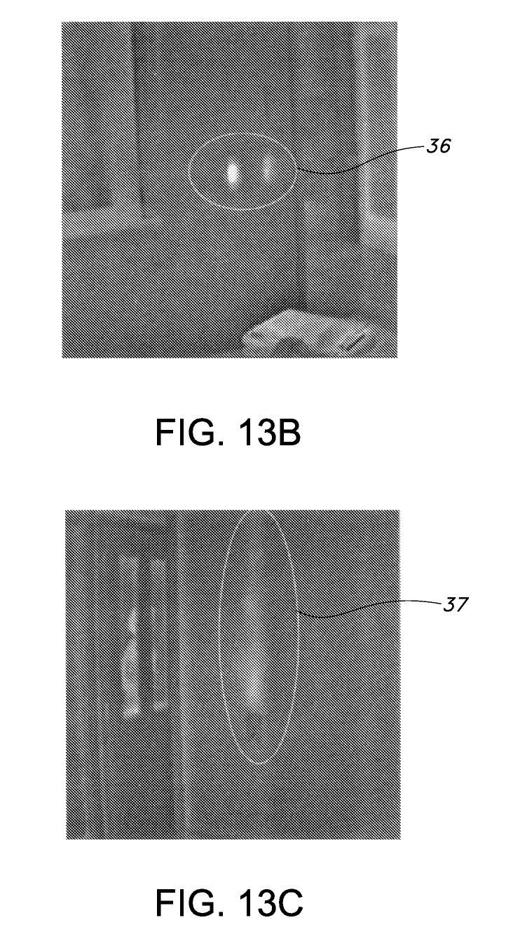

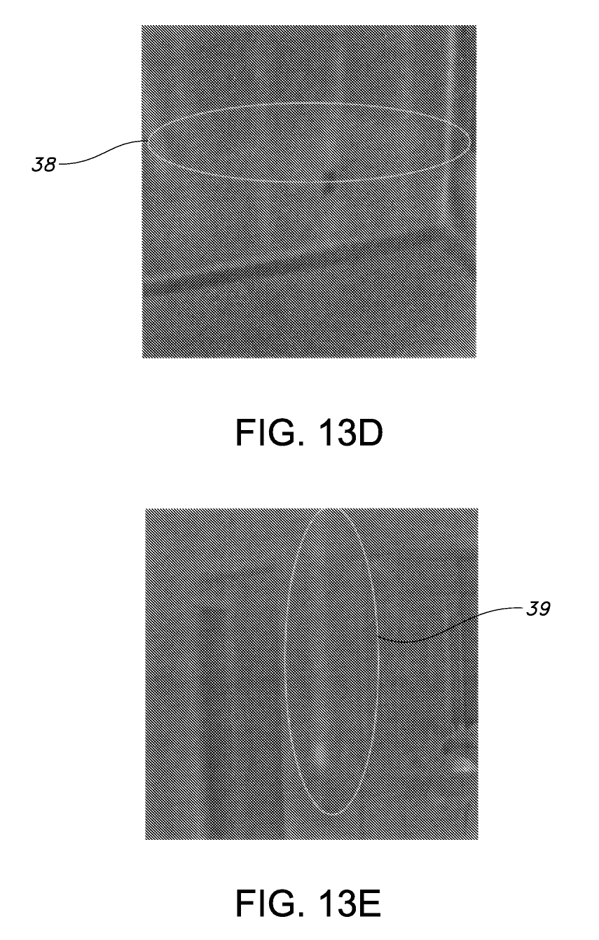

A problem in a residential building component will appear as an anomaly in a temperature profile. An anomaly is any deviation from the normal characteristics of a specific type of residential building component. FIGS. 4, 13 A-E and 15-31 show a series of temperature profiles and temperature profile anomalies. A temperature profile anomaly is indicative of a possible problem with the residential building component. These building problems include but are not limited to the following: structure, insulation, moisture, electrical hot spots, water leakage, unwanted pests such as termite, mice, and rats, and air duct leakage. The term residential building components include elements of a building, such as walls, ceilings, windows, plumbing fixtures, etc. The residential building component can be an exterior component, such as exterior wall (wood, bricks, stucco, EIFS or vinyl siding), eaves, fascias and interior surface of a pitched roof. Similarly, the residential building component can be the electrical system. Additionally, the residential building component can be an interior structure, such as insulation, wiring, air duct, and finished surfaces.

The corresponding video images of the potential building problems are recorded by digital recording device 2. A digital recording device 2 is a means to record a digital image. The thermal imaging camera 1 is connected to digital recording device 2 by cable 5. the video output of the infrared camera 1 is input to the video recording device 2. Thermal imaging camera 1 may be any of a number of commercially available infrared cameras conventionally used by structural engineers, police and the military. In order to improve the accuracy by which thermal imaging camera 1 detects potential problems, the thermal imaging camera 1 may further include target recognition software, such as matched filtering software which compares the frequency spectra of reference images, thereby reducing the level of skill required of the camera operator.

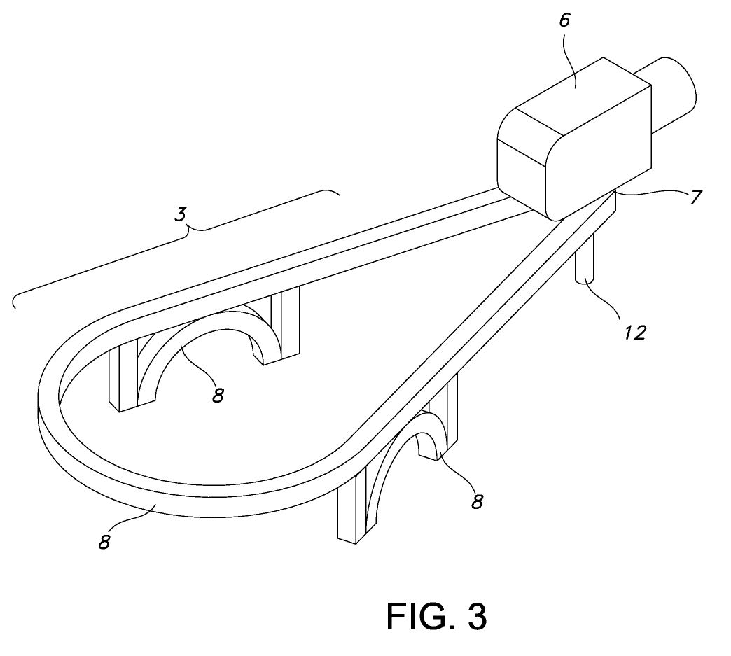

While the invention is not limited to a particular thermal imaging (infrared) camera 1, there are various thermal imaging systems that are sensitive enough and capable of evaluating residential building components. For example, Raytheon's Control IR2000B or 300D thermal imaging system, although not the most sensitive, has shown good consistency and accuracy. It is robust and, most importantly, relatively inexpensive. Those skilled in the art will appreciate that it is also possible to use other types of thermal imaging cameras 1 so long as they are sufficiently sensitive to detect temperature variations normally down to 0.12 degrees Celsius or lower (e.g., 0.08 degrees Celsius) and cover an approximate frequency range of the infrared spectrum emitted by residential building components. The infrared detector resolution is preferably 240×320 or higher; but can be 120×160 (with a good thermal window). It will, of course, be appreciated by those skilled in home inspection that the thermal imaging camera 1 and the digital recording device 2 may be combined into a combination unit 6 as shown in FIG. 3. However, a combination unit 6 presently carries a much higher price tag, which makes the residential application much less attractive.

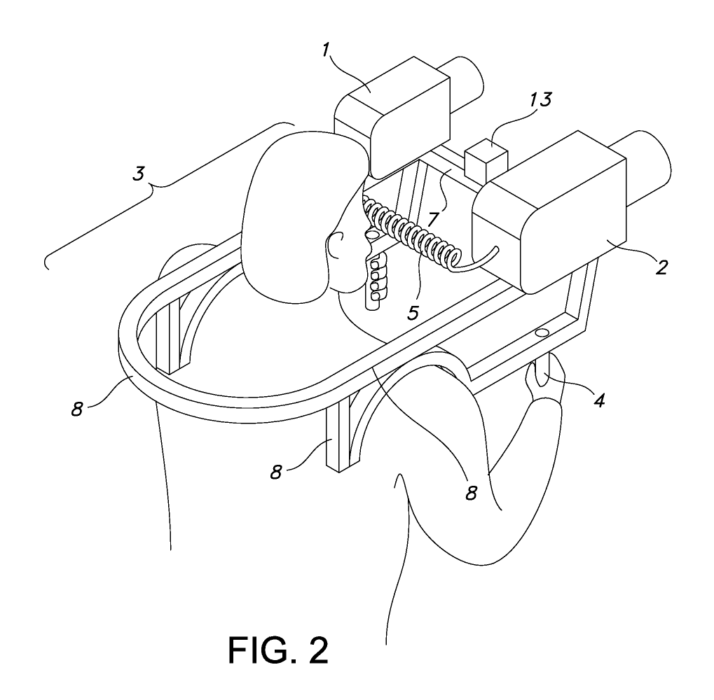

While one particularly preferred embodiment is the new arrangement specifically designed to securely position the device in front of the inspector for ease of operation, out of harm's way to protect the sensitive infrared camera, and to allow the inspector to have both hands free when needed to move an object. As shown in FIG. 1, a harness apparatus 3 allows both the thermal imaging camera 1 and the digital recording device 2 to be mounted in a balanced, safe and easy-to-use position for the inspector. As shown in FIG. 2, the harness apparatus 3 is designed to be securely mounted over the inspector's shoulders. The harness apparatus 3 allows the operator to operate with his hands with the aid of the handles 4 or without hands in the event that the hands need to be free to perform other functions, with add chest support (not shown). The harness apparatus 3 is configured to support at least one residential inspection device. The residential inspection device can include, for example, a thermal imaging camera, video recording device, a means to transmit or record a digital recording image, such as a LCD or a digital camera, a combination unit thermal imaging camera recording and a wireless communication apparatus.

More specifically, the harness apparatus 3 in the preferred embodiment has a first portion 7 for supporting at least part of a thermal imaging camera 1 and if desired at least part of the digital recording device 2 such as a digital recording camera. In this embodiment, the thermal imaging camera 1 and the digital recording device 2 are attached to the first portion 7 of the harness 3. This first portion 7 is connected to a second portion 8. The first and second portions form an enclosure. The enclosure is of sufficient size to accommodate a human torso as shown in FIG. 2. The thermal imaging camera 1 in this embodiment is operably connected via a cable 5 to a digital recording device 2.

The second portion 8 is generally “U” shaped “with the leg portions of the “U” being sufficiently spaced apart to accommodate a human torso. The second portion 8 can function to support at least part of the thermal imaging camera 1 and at least part of the digital recording device 2. The second portion 8 is configured to receive the shoulder portions of a human. The term configured to receive the shoulder portion of the human torso means that the second portion 8 rests on the shoulder so that the harness 3 is above the shoulders. In one embodiment, the residential inspection devices are attached to the second portion. The first portion 7 and second portion 8 are configured to support at least one residential inspection device in that they provide a flat, rigid platform for the residential inspection devices. The second portion 8 can include a plurality of handles 4 which project generally downwardly. The plurality of handles 4 may be of any shape to be gripped by the hand of the person wearing the harness apparatus 3. The second portion 8 can be formed of two parts to make a more rectangular enclosure (not shown).

In the alternate embodiment shown in FIG. 3, the harness apparatus 3 is a generally triangular shaped substantially one piece unit. In this embodiment, a combination unit thermal imaging camera recording device 6 is affixed to the first portion 7 of the harness apparatus 3. The harness apparatus 3 includes a second portion 8 adopted to retain the shoulder portion of a human torso. A single handle 12 can be made one piece with the unit or attached to the harness apparatus 3.

The embodiment shown in FIGS. 1 and 2 can include a means to transmit a digital image to a central receiving facility. This communication apparatus 13 can be affixed to harness apparatus 3. Various wireless communication apparatus are known to those skilled in the art, such as a wireless internet communication system.

Exterior Residential Application—The use of the infrared equipment for exterior inspection has proved beneficial in cases where the exterior clad is made of wood and wood product siding, EIFS, or vinyl siding. The thermal properties of these materials are such that the infrared camera can discern moisture infiltration, some structural anomalies, and the occasional insect infestation. The same can be said for inspection of eaves and fascias utilizing the infrared equipment.

The present process provides a fast and accurate method for determining the presence of uncontrolled moisture on the surface, beneath the polymer coating, or against the substrate of an EFIS structure, without invasive visual inspection methods. Thermal imaging to detect the presence of uncontrolled moisture within an EIFS structure can be conducted under certain conditions. These conditions include:
1. Make use of direct sun light to open the thermal window;
2. Rely only on ambient temperature for water evaporation to open the thermal window; and
3. Induce heat to the EIFS wall to open the thermal window.

When relying on the sun light energy to open the thermal window, a thermal window opens as soon as the sunlight hits the structure and as soon as sun light leaves a wall. The duration of the thermal window depend on the amount of moisture trapped under the surface.

Rely only on ambient temperature for water evaporation to open thermal window. Under this condition, a very low wind less than 1 mph, outdoor ambient temperature greater than 45° F.; and elevation of the interior temperature of the resident building to a degree to facilitate contrast of the at least one temperature profile is needed to be able to detect moisture. This increase in temperature occurs 30-60 minutes before inspection. The increase in temperature to facilitate contrast is usually 10° F. higher than the normal temperature setting for more than 45 minutes.

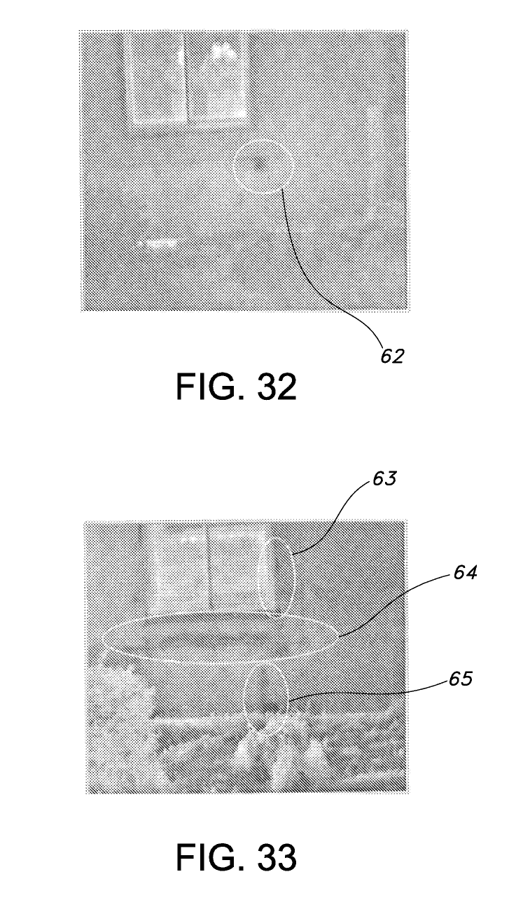

Now referring to FIGS. 32 and 33, thermal profiles, under no direct sun light, of the same EIFS structure under different conditions, show that certain conditions produce a thermal scan in which substantially all moisture can be detected, nondestructively. More specifically, in FIG. 32, the ambient air temperature is 28° F., with a wind speed of 5 m.p.h, while in FIG. 33, the ambient air temperature is 45° F., but the wind speed is less than 1 m.p.h. In FIG. 32 moisture shown at 62. In FIG. 33 moisture is shown at 63, 64 & 65. The house temperature was set to 75° F.

Induce heat to EFIS wall to open the thermal window. The addition of heat can be created by a man made force air heater. It can be heater of any fuel source, as long as it is capable to blow warm (hot) air toward the EIFS wall of interest from a distance of at least 15 feet away. Fuel source (such as heating oil) must be able to induce heat evenly to the EIFS wall of interest.

Thermal window for inspecting within either finished exterior wall, interior wall or exterior roof overhang (eaves) can also be obtained when moisture allowed to evaporate. In order for water molecule to evaporate it must absorb heat energy from its surrounding as a result the moisture spot appear as cold spot. When the thermal window opens, the operator will be able to see more and more visual definition of the thermal differences within the building components and its components. This means that as the window opens, the internal components of a wall's structure will become more and more pronounced as displayed on the video screen of the equipment, leading to better resolution and increased accuracy of the inspection.

More specifically, this process relates to an inspection of an exterior residential building component. The exterior residential building component is selected from the group consisting of: wall, fascia, and eave. The process of obtaining a temperature profile of an outside residential component implies that a thermal window exists, in that, a useful temperature profile could not be obtained without thermal differences between components. The next step involves obtaining a temperature profile of the exterior residential building components. Then, a temperature profile is recorded on a digital recording device. The digital recording is reviewed to detect any thermal anomalies. Now referring to FIG. 4A, an EFIS exterior wall is shown with a regular video photograph. In FIG. 4B, a temperature profile, taken in the morning after sunrise when the thermal window has just begun to open shows a warm spot 15 which in indicative of moisture within an EFIS wall.

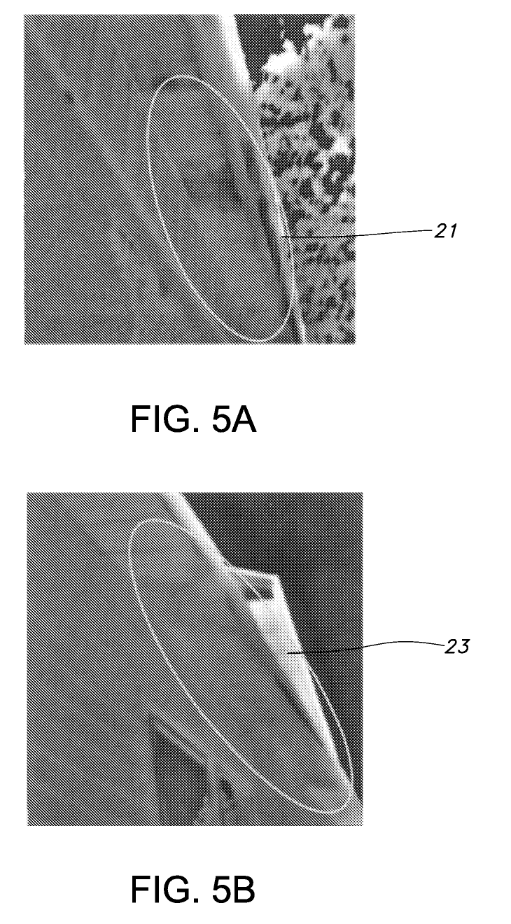

In FIGS. 5A, and 5B, temperature profiles, taken when moisture is allowed to evaporate shows anomalies as dark spots 21 and 23 under the vinyl siding. This moisture is not visible to the human eye. These anomalies 21 and 23 are indicative of the presence of moisture under the vinyl siding.

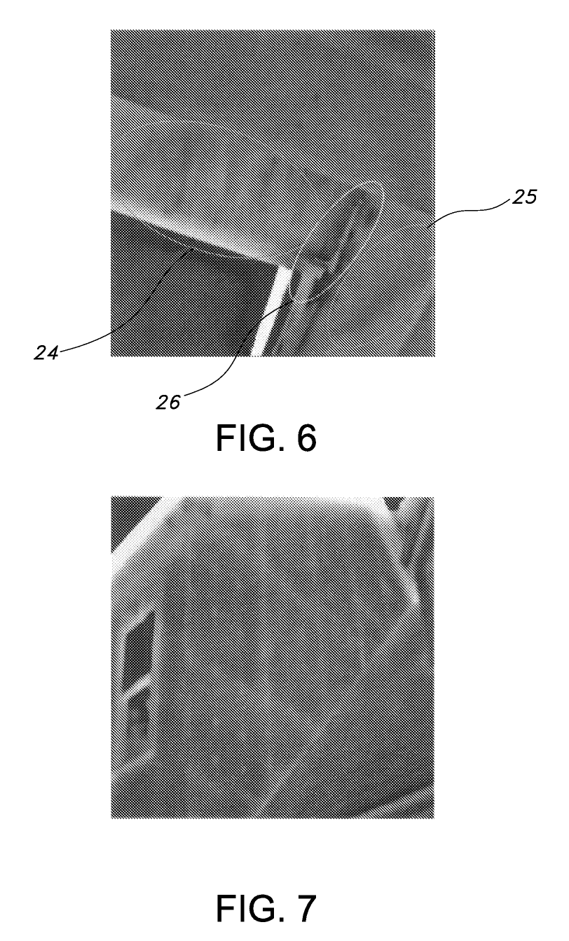

Now referring to FIG. 6, a temperature profile, taken in the morning after sunrise of an eave shows a number of anomalies. Anomaly 24 and 25 are indicative of current structural deformations due to past infiltration of water (dried) and anomaly 26 is indicative of the presence of moisture.

FIG. 7 shows a temperature profile taken in the morning of a dry EFIS wall showing no thermal anomalies.

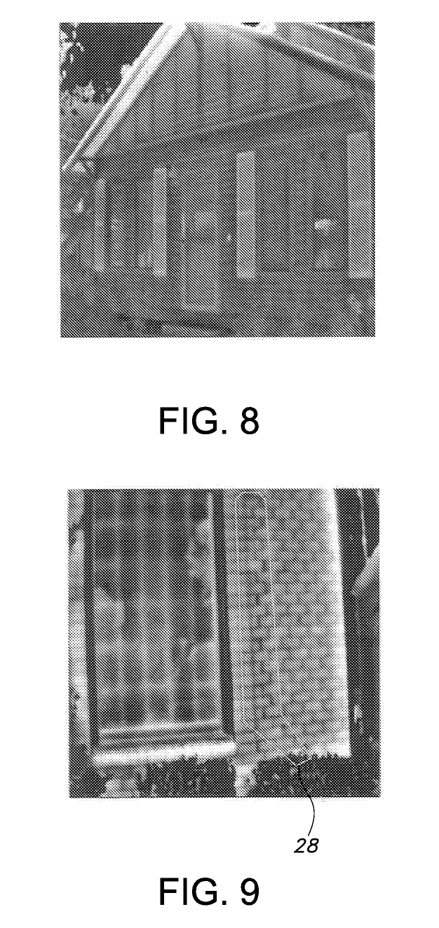

FIGS. 8 and 9 show temperature profile taken at noon. In FIG. 8, no thermal anomalies are present, while in FIG. 9, a thermal anomaly 28 shows a cracked brick wall. This temperature profile shows as a thermal anomaly because moisture is in the crack in the wall.

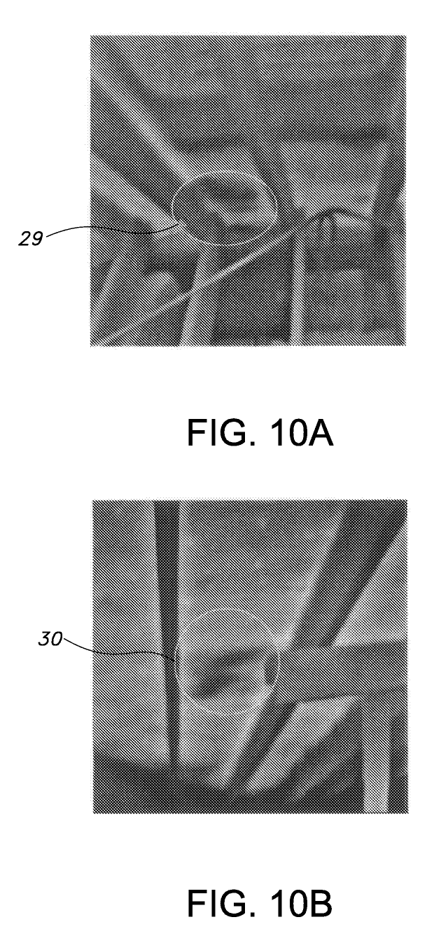

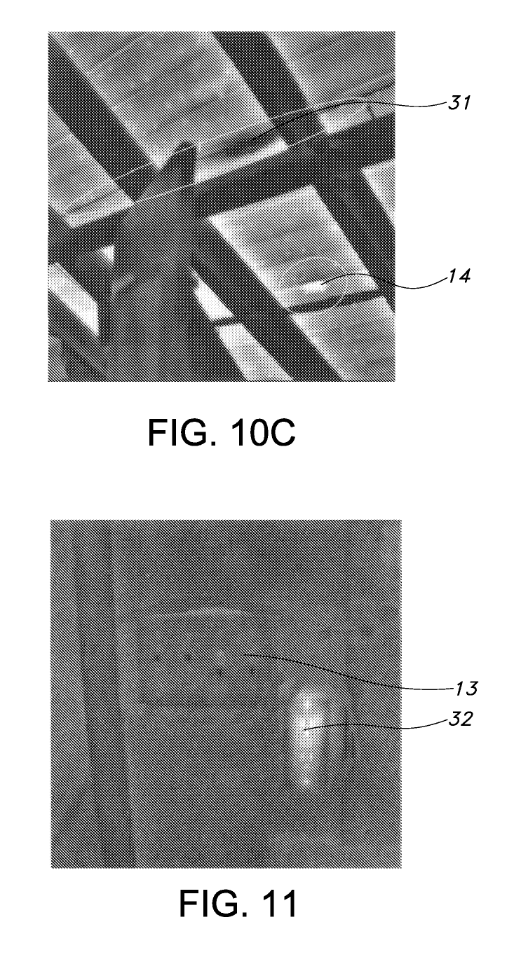

Roofs (Pitched Roof) Applications—In the heat of the day, the thermal load on a roof can be quite striking to view through an infrared detector. Anomalies show up as dark shadows against a bright background. More specifically, referring to FIGS. 10A and 10B, thermal anomalies 29 and 30 are shown as dark spots. This type of thermal anomaly is indicative of water damage to a roof. These types of thermal anomalies are present for two to three days after rain during the summer time and up to few weeks in the cold season. This period is considered the thermal window for this application. In the present method, a pitched roof is defined as a roof having a slope ranging greater than a rise of 1 by 12 inches.

A pitched roof is inspected by obtaining a temperature profile of the interior surface of the pitched roof from inside of the attic within three days to a few weeks of rain depending on the time of year. This method using an infrared camera coupled to a digital camera can provide information on active water leaks prior to the leaks being visible. Water damage to a roof as seen from the interior of the attic space is revealed as dark shadows against the normally bright roof decking. When conducting this method, additional confirmation can be obtained by observing: (a) standing water below the stain or interior staining or water damage on finished surfaces; or (b) presence of moisture confirmed from results of moisture meter test; or (c) visible damage to the decking such as: presence of a dark stain coupled with positive moisture meter reading; or presence of visible active growths of mold or mildew; or decking delamination; or decking discoloration; or combinations of the above.

This invention can be applied to pitched roofs to inspect the condition of a residential roof. More specifically, in FIG. 10C the source of a leak can be traced by assessing the thermal anomaly 31. The leak can be followed from left to right to find the leak shown as the dark spot. Additionally, this method can also be used to detect structural deformation. The thermal anomaly shown as the white irregular spot 14 is indicative of a puncture in the roof decking material with the shingles covering over the puncture. This method can also be used to detect structural damage such as cracks. The temperature profile is recorded on a digital recording device 2.

Electrical Applications—Many problems in the electrical systems are the result of abnormal heating associated with high resistance or excessive current flow. Thermal imaging scan (Infrared thermography) allows us to see these invisible thermal patterns before damage occurs. A thermal imaging scan allows an inspector to quickly locate the suspicious electrical hot spots from among the hundreds and thousands of potential problems. The primary benefit of inspecting residential building electrical system is to increase safety.

When electricity (electrical current) flows through a circuit, part of the electrical current is converted into heat energy. This is due to the normal electrical resistance in the circuit. High resistance has been used to produce heat or light to make our life more comfortable. However, in many instances, heat is an unwanted by-product that results in energy lost, costly damage, and hazarded condition. For example, when resistance is unusually high due to an over fuse under size conductor, loose connection, rusted connection, defective switch, poor workmanship, the circuit may become hot. Electrical components can become hot enough to melt the electrical insulation and result in a house fire.

There are two major categories of electrical hot spots: contact surface over heat and overload. 1. Contact surface over heat—This type of problem occurred when electrical current flow through a single point of contact with high resistance. They usually associated with rusted or warned out switch contact. The same problem can also occur to electrical connector. 2. Overload—This type of problem occurred when high amounts of current flow through a circuit. They are usually associated with over fuse under size conductors.

Infrared detection provides another level of inspection for the electrical service throughout the house. This method to detect a potential overload of an electrical circuit in a residential building includes turning on substantially all light switches and exhaust blowers in a residential building. (at least 30 minutes prior to obtaining a temperature profile). Next a temperature profile is obtained of each electrical outlet in the residential building. The temperature profile is assessed for a thermal anomaly. If a thermal anomaly is detected, the next step can be to determine compliance with safety electrical guidelines.

Safety Electrical Guidelines: (1) make sure no over fuse (over breaker); (2) make sure proper grounding; (3) make sure no hot neutral reverse; (4) make sure no open ground; (5) no cracked wire; (6) no discolor wire; (7) no outlet painted over; (8) make sure all other electrical safety installation procedures are followed (such as aluminum wire, and GFCI).

The purpose of turning on substantially all of the light switches and substantially all of the exhaust blowers is to allow current to flow through the normal electrical loads while the inspector performs the exterior inspection. If a few light switches or blowers are missed, this still constitutes “substantially all”. The order of which is turned on first is not important between the light switches and the exhaust blowers. During the time the inspector is inspecting the exterior portion of the house, the electrical system in the house has the opportunity to heat up under normal load. If an electrical circuit is drawing substantial amount of current that the circuit can't support, or in the case of faulty connections or faulty switches, the circuit will heat up and can provide a thermal signature indicating a potential problem with that particular circuit.

GFCI outlets and dimmer switch controls will always show a light heat signature in excess of surrounding materials because the GFCI outlet has an active circuit in operation at all times to test for electrical leakage. The dimmer switches are rheostats that adjust current flow to things like chandeliers, fans, etc. Since the current is adjustable, under load the dimmer switch will also develop a heat signature in excess of that of the surrounding materials. Do not construe these normal heat signatures to mean that an inspector should not evaluate each dimmer switch or GFCI outlet. On the contrary, the inspector should take time to determine if the temperature differential is unusually high for each of the above. If the dimmer switch or switch plate cover is hot to the touch and greater than 30° C. than the surrounding wall temperature (ambient air temperature), further investigation is warranted. The same is true of a GFCI that is unusually warm or hot to the touch and greater than 30° C. than the surrounding wall temperature (ambient air temperature).

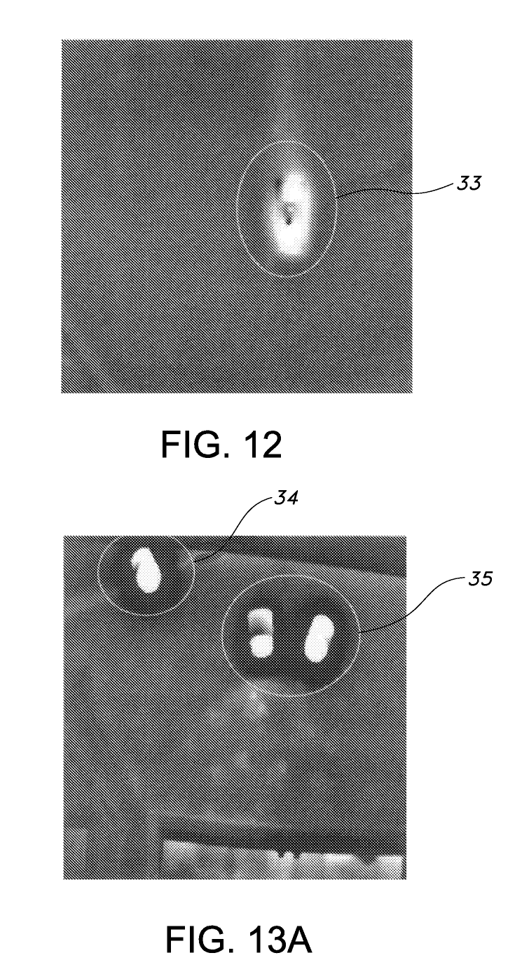

Referring to FIGS. 11, 12, 13A and 13B, various temperature profiles of electrical components are shown. These temperature profiles are made as part of a process to detect a potential problem with an electrical circuit of a residential building. In this method, the first step is to turn on substantially all of the light switches in the residential building. Then, a temperature profile, such as those shown in FIGS. 11, 12, 13A and 13B is obtained. Each of the temperature profiles is assessed for an anomaly. For example, FIG. 11, shows an on/off switch 13 and a GFCI outlet 32 that are normal 80. FIG. 12, is a temperature profile of a dimmer switcher that shows an anomaly 33 indicative of a very hot dimmer switch. Similarly, FIGS. 13A and 13B show thermal anomalies 34, 35 and 36 indicative of heavily loaded electrical circuits. FIGS. 13C-E show thermal anomalies indicative of a hot electrical wire 37-39. When a thermal anomaly is detected, the next step, in the preferred embodiment, is to direct the designated entity to consult with a licensed electrician.

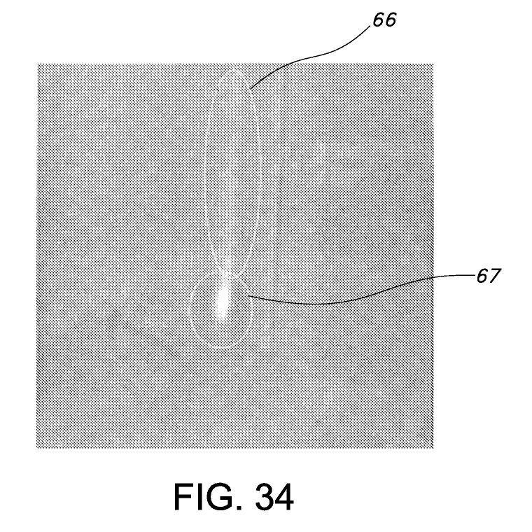

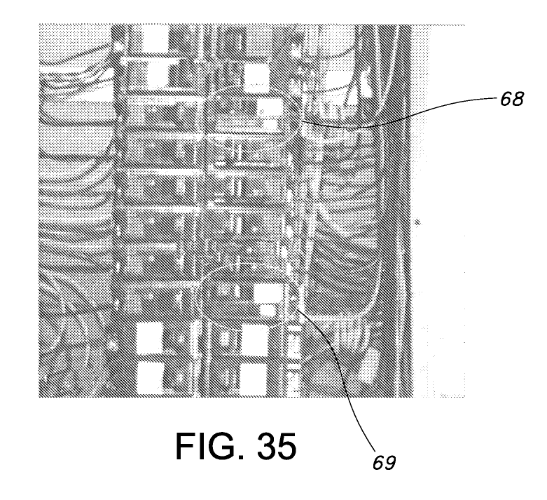

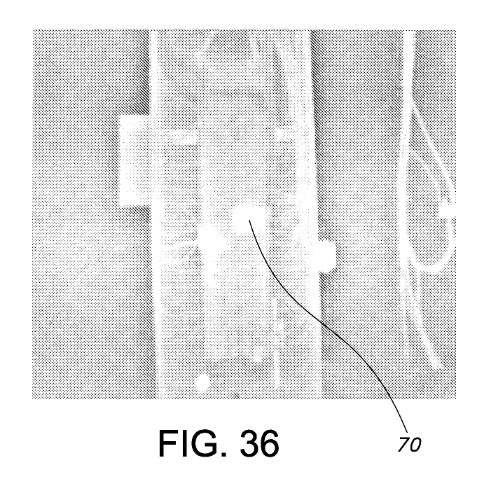

Now referring to FIGS. 12 and 34-37, the following electrical hot spots can be identified in a residential building: faulty connections (rust, nipped wire, etc.); faulty switch FIG. 12 at 33 (rust, old, poor quality, abused), hot spots due to human mistakes (e.g. wire puncture by nail or screw FIG. 34 at 66 & 67); over loaded; and nonworking component (e.g. failed GFCI FIG. 35 at 68 & 69 & FIG. 36 at 70) (working GFCI produce small amount of heat that can be picked up by infrared camera).

Interior Residential Applications—The interior building components of a residence can be thermally scanned. The interior building component includes: wall insulation, plumbing, structural members and air ducts.

The inspector should turn on the heating/air conditioning by setting the interior thermostat(s) to 10° F. above or below the ambient exterior temperature shortly after arrival on site. When outdoor temperature is above 70° F., turn on the air conditioner to 10° F. lower. When outdoor temperature is less than 70° F., turn on the heat to 10° F. higher. This provides two of the three major requirements to obtain a suitable thermal gradient within a house: 1) increasing temperature differential between finished surfaces and interior ambient air temperature, and 2) interior air movement throughout the living spaces of the home. The temperature differential provides the gradient. The moving air enhances the gradient and sharpens the contrast between hidden moisture within structures and substrates and other areas within the structures or substrate, permitting the thermal camera to visually illustrate those thermal differences.

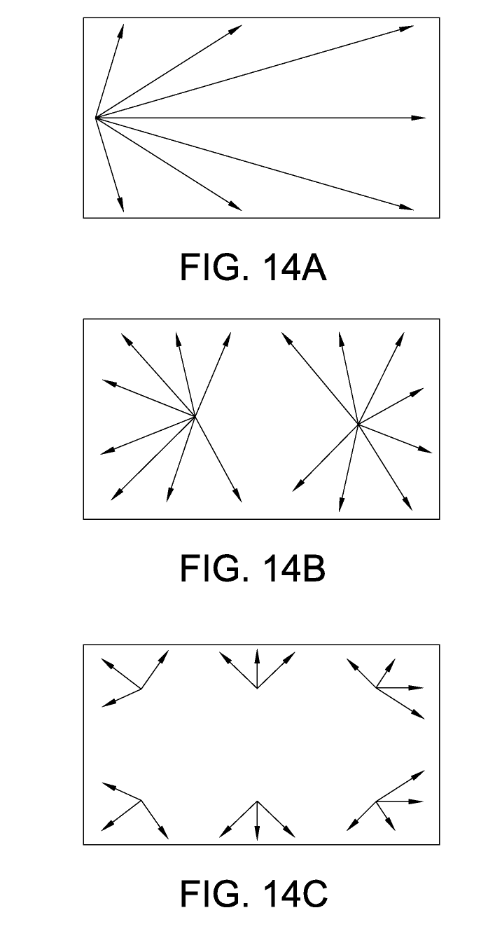

Referring to FIGS. 14A, 14B and 14C, a method to scan an interior residential building component is disclosed. In the first step of this scanning method, an operator using the thermal imaging camera 1, digital recording device 2 and harness apparatus 3 shown in FIG. 1 scans from afar as shown in FIG. 14A. Next, the operator scans from mid-range pointing the imaging camera 1 from two equidistant points in a room as shown in FIG. 14B. In the next step, as shown in FIG. 14C, a scan from close range is accomplished by scanning a plurality of points within a smaller arc. Different inspectors may have a different way of scanning the interior of the building; however, any method adopted should be systematic to insure completeness. The combination of the use of the harness apparatus 3, the use of a systematic method to scan and the use of the methods to improve image contrast result in a rapid method to nondestructively inspect a residence.

When assessing the temperature profile, it is important for the inspector to confirm the dark spots are not due to: (1) improper setting of the infrared camera; (2) cold air from HVAC or cold outside air; (3) water pipes; (4) knots of wood; and (5) improper installation of insulation.

(1) Insulation—Infrared wall inspection can some time be confusing due to various reasons. The following discussion provides a basis to review thermal scans conducted in different seasons.

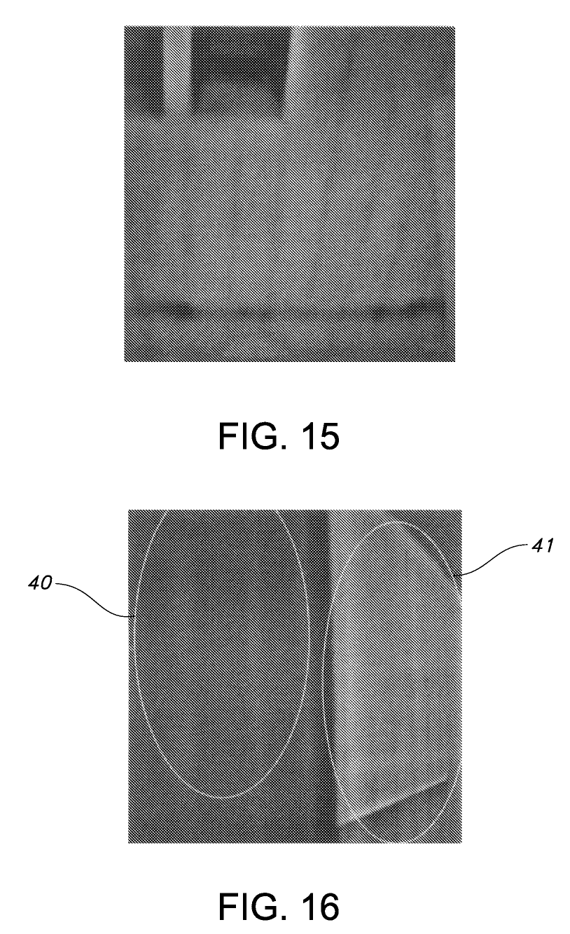

Now referring to FIG. 15, 2×4 studs and ceiling rafters appear as cold in a well-insulated wall during the winter season. This is due to the fact that insulation is a relatively poor heat conductor as compared to 2×4 wood stud and ceiling rafters, as a result, 2×4 wood stud ceiling rafters lose relatively more heat than the insulation (from indoor to outdoor).

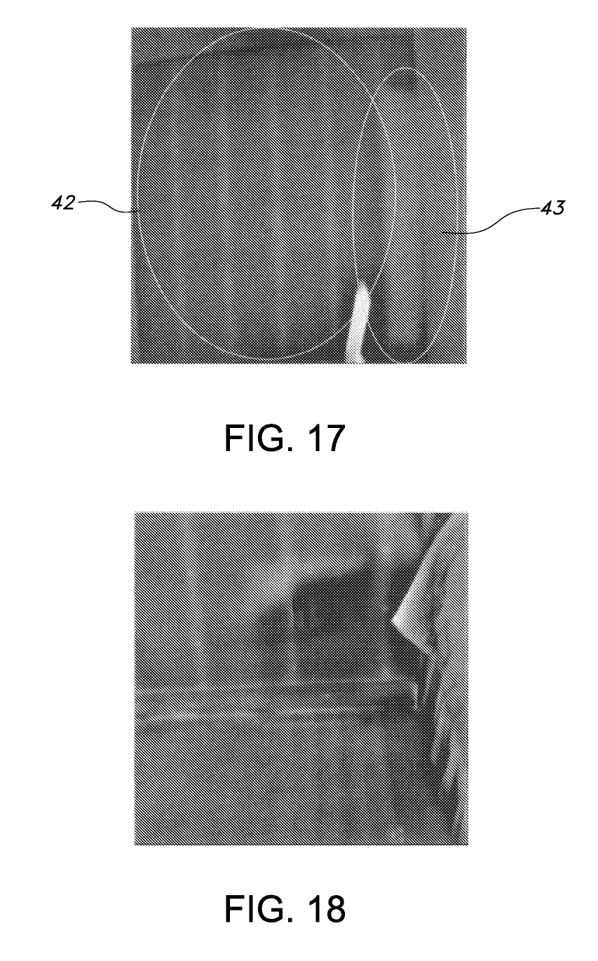

Now referring to FIGS. 16 and 17, 2×4 studs 40 and 42 appear as warm in uninsulated or very poorly insulated wall (left half of the wall) during the winter season. This is due to the fact that 2×4 wood stud now is a relatively better insulator as compared to uninsulated air space, as a result, the 2×4 stud looses relatively less heat than the uninsulated air space (from the indoor to the outdoor). The right portion 41 of FIG. 16, 43 of FIG. 17 appears to be insulated.

Now referring to FIG. 18, 2×4 studs appear as warm in well-insulated walls during the summer season. This is due to the fact that 2×4 wood stud is a relatively good heat conductor as compared to insulation between studs; as a result 2×4 studs conducts more outdoor heat then the insulated wall section.

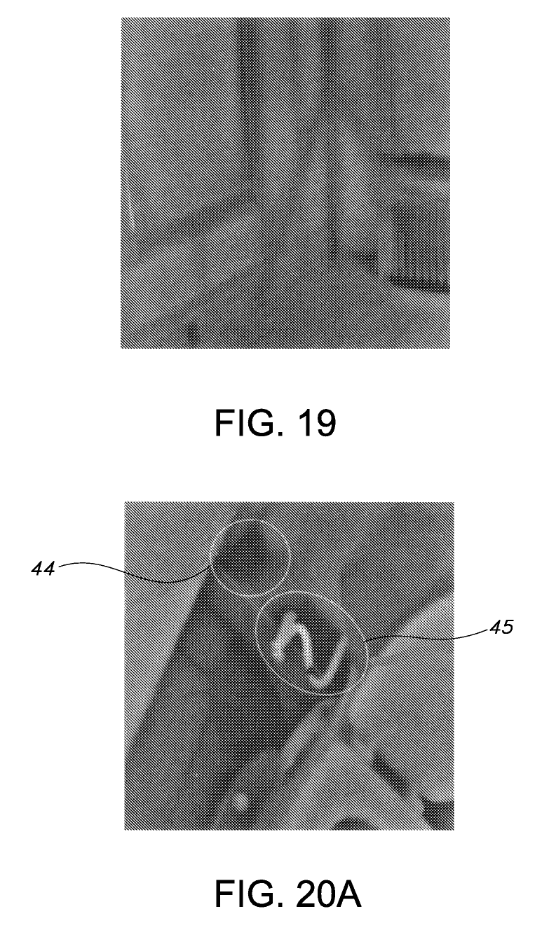

Now referring to FIG. 19, 2×4 studs appear as cold in uninsulated or very poorly insulated wall during the summer season. this is due to the fact that the 2×4 wood studs now is a relatively better insulator as compared to uninsulated or poorly insulated air space, as a result 2×4 now conducts relatively less outdoor heat than the uninsulated or very poorly insulated wall section. The wall and ceiling of a residential building can be inspected to determine if they are uninsulated using this method.

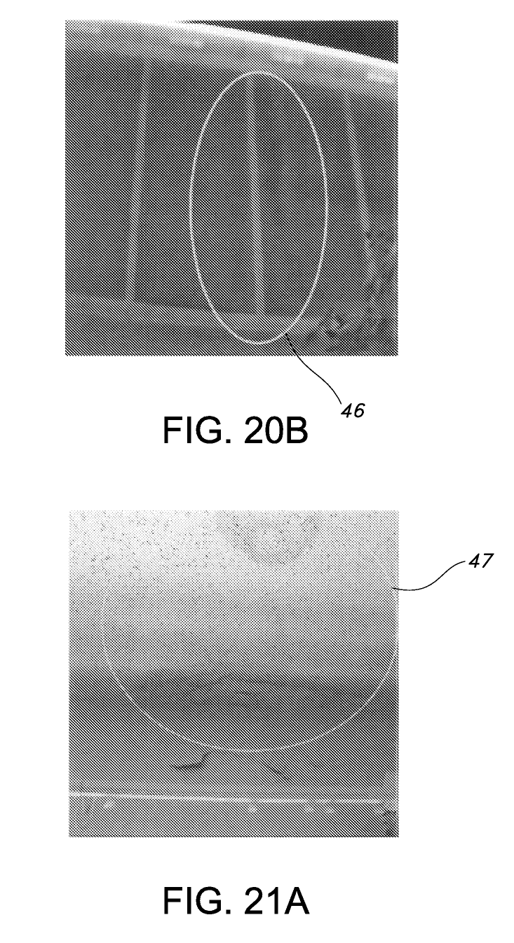

(2) Plumbing—Hidden plumbing leaks can pinpoint within finished surfaces utilizing the thermal camera in cases where visual inspection was not possible. In FIG. 20A, a temperature profile is obtained for plumbing fixtures after the thermal window is created. The term plumbing fixture can include the plumbing fixture itself or associated piping. The temperature profile is recorded on a digital recording device and reviewed for a thermal anomaly. The temperature profile shown in FIG. 20A shows anomalies 44 and 45, which are indicative of a moisture leak behind the wall. FIG. 20B shows an air conditioning Freon pipes with a darker portion 46 indicative of low pressure (cold) return pipe. The temperature profile of FIG. 20B is a normal profile for an air conditioning Freon pipes.

(3) Condensation—Poorly managed moisture in a building can cause considerable damage that is often concealed for some time. Moisture in vapor form in the air causes no harm to building. However, when this moisture condenses to liquid form at the wrong place, damage can occur. The tricky part is, this often happens in areas that are difficult or impossible to see (within wall cavity) or difficult to determine the cause behind the problem. In the event of water leakage in a building, as the water begins to evaporate it produces a colder area, which can also be easily registered by the infrared sensor (camera).

In the wintertime the interior air in an average house at 70° F. and 40% relative humidity will be saturated and will condense to water droplets when the temperature drops to 45° F. It is not too difficult to understand how indoor air leaking into a wall or attic space will cool quickly. The outside of your walls and underside of the roof in your attic space is much closer to the outdoor temperature. When this bundle of warm moist indoor air leaks out through the wall or ceiling, it will cool and condense in the wall or ceiling/roof.

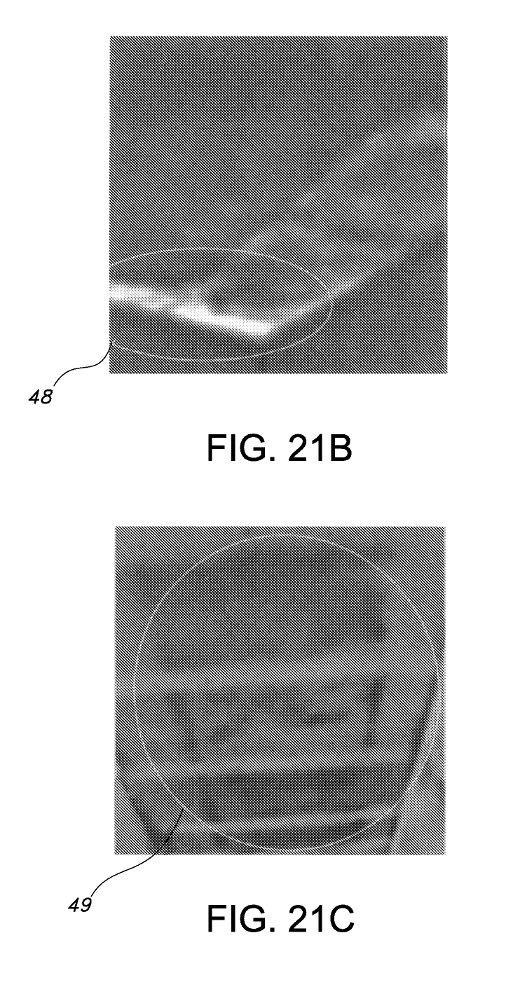

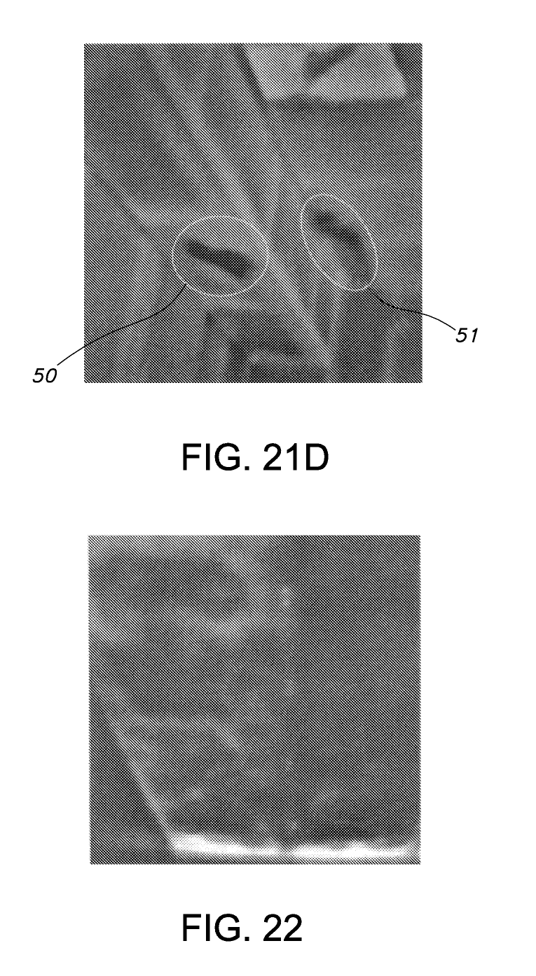

Condensation can also occur on interior ceiling surface as shown in FIGS. 21A and 21B. FIG. 21A was taken 4 feet away from the ceiling. The anomaly 47 is visual image indicative of moisture on the ceiling. The temperature profile shown in FIG. 21B was taken 15 feet away from the same ceiling shown in FIG. 21A. The anomaly 48 is indicative of missing insulation in the ceiling. During the cold winter month, the uninsulated ceiling becomes cold and when the high humidity interior air comes in contact with the cold ceiling surface, condensation often occurs on the interior cold ceiling surface.

(4) Moisture in Air Duct—Additionally, FIGS. 21C and 21D show anomalies 49, 50 & 51 which are indicative of moisture in an air duct. This happens most often when there is no insulation in that particular section of the ceiling due to poor workmanship or due to rodent activities plus the occupant of the house has the lifestyle of generating high level of moisture with inadequate ventilation during the winter season. The uninsulated ceiling is closer to the cold outdoor temperature. When the high level moisture indoor air comes in contact with the cold interior ceiling surface (the hotter the air, the higher it rises and more moisture it can hold), it will cook and condense. These types of condensation problems were often mistaken as roof leaks. This happens when there is insufficient insulation around the air duct and poor workmanship or aging insulation. Condensation accumulates in cold air (in summer) eventually dripping into the ceiling under the duct.

Mold—Condensation in building can cause mold. Building materials that remain wet for between 24 to 48 hours have the potential for mold developing and developing quickly. Molds thrive on organic material. One organic material of particular importance is cellulose. Cellulose makes up residential components such as ceiling tile, dry wall, insulation, books, carpeting, upholstered furniture, curtains, food and etc. The most important thing is to find the source of causing the mold to grow, which is the moisture. A good mold investigator focuses on locating moisture not microbiology or sampling. Condensation, construction techniques, and water intrusion lie at the heart of a proper mold investigation. Mold issues begin and end with moisture issues—Caoimhin P. Connell (Senior Industrial Hygienist for Colorado industrial hygiene and toxicological consulting firm). The method for inspection of interior residential components can be applied to locate the source of moisture. The source of the moisture can be correlated with mold growth.

There is a limit to how much moisture can be stored. Wood is able to safely store up to 20% moisture by weight. Moisture levels above this can cause rot, mold and mildew. The preset method can be used to locate moisture and correlate this moisture with mold growth.

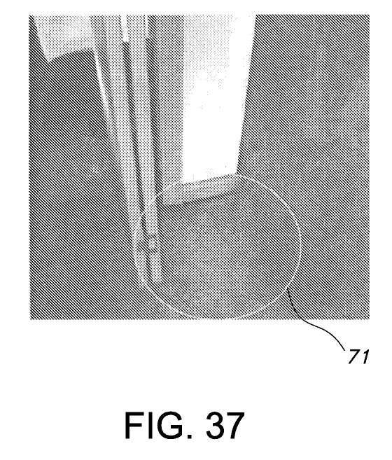

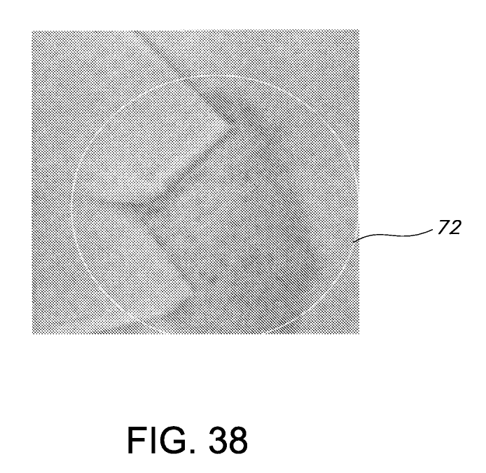

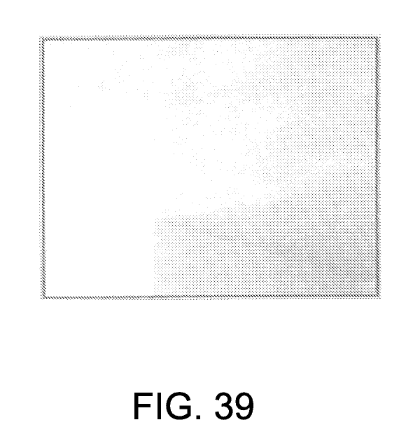

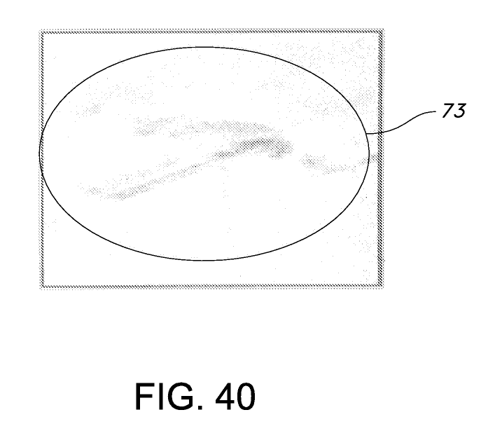

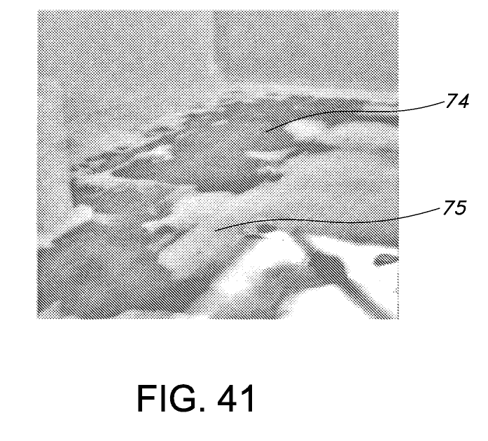

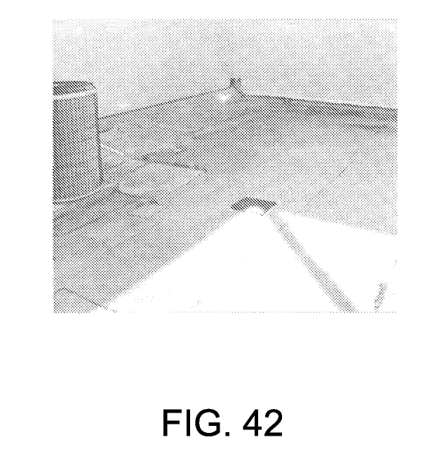

The application of the present thermal imaging techniques provide a way to identify and locate uncontrollable water problems, such as shown in FIGS. 21A, 21B, 21C and 21D. The temperature profiles can be reviewed to identify a thermal anomaly indicative of moisture. The location of the moisture can be identified. The location of water problems can then be sampled for mold spore levels. The mold spores can be collected by traditional mold sample collection technique. The species can be identified and the mold spore level can be determined. More specifically, mold can be identified by a thermal scan of carpet. In FIG. 37, a visual photograph of a carpet 71 can be compared with a thermal scan to show moisture under the carpet FIG. 38 at 72. Additionally, as shown in a comparison of FIGS. 39 and 40, moisture 73 in a ceiling can be shown through an infrared scan. Similarly, a comparison of FIGS. 41 and 42 show moisture 74, 75 under a flat roof undetected in the photograph, FIG. 42. In the preferred embodiment the mold inspection procedure includes: Step 1: Infrared scan to locate the source that cause mold to grow which is the uncontrolled moisture problem and Step 2: Traditional mold sample test.

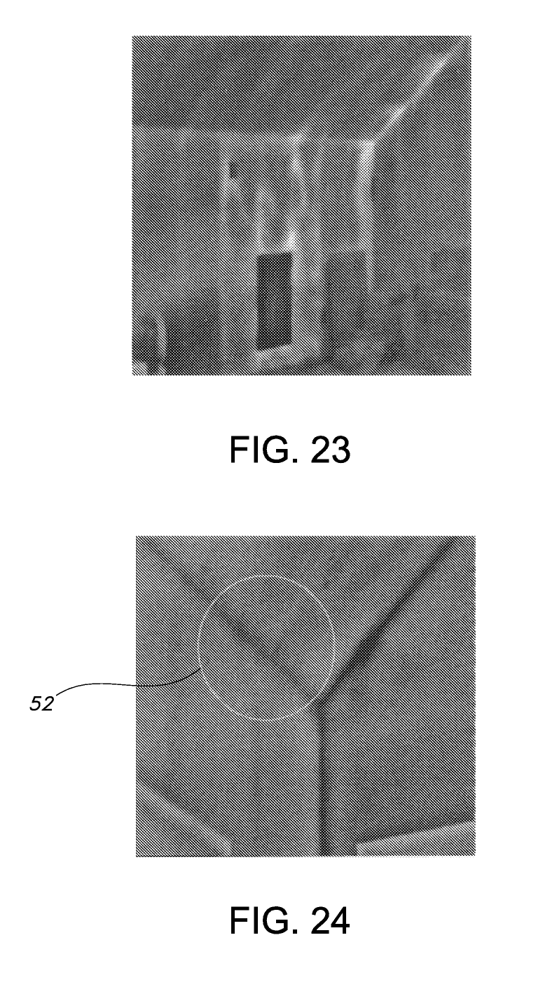

(6) Small Animals—As for small animals, such as mice, rats, squirrels, and etc. when they infest a house attic or wall space, they tend to burrow through insulation, creating air gaps in the normally evenly distributed insulation and thereby changing the thermal properties of the insulation, leaving visual evidence of tunnels and nests that would normally be invisible to even the trained eye. FIGS. 22 and 23 are thermal profiles of an interior component of a residential building. A review of a digital recording of this thermal profile shows an anomaly that is interpreted as tunnels in insulation in the ceiling (FIG. 22) a tunnel in the insulation in the walls. (FIG. 23). The reason that infrared camera can locate these tunnels is because these tunnels allow exterior air to come in close contact with the ceiling.

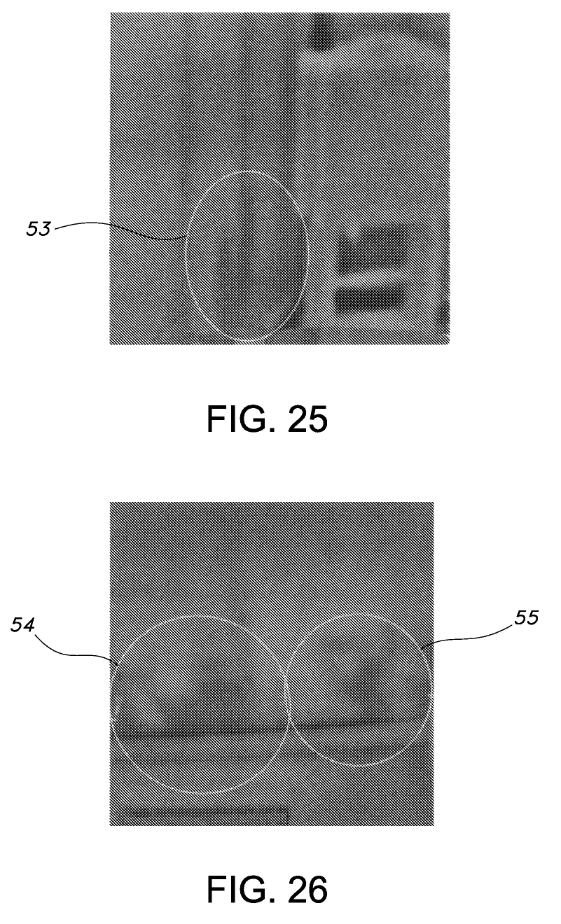

(7) Structural Misalignment or Damage—In the case of less than perfect construction techniques, the trained observer can spot missing, mis-aligned or damaged internal structural members such as studs, headers, trimmers and the like. In some cases, those damaged or missing members may contribute to otherwise unaccounted for interior damage that would normally point to foundation troubles, but which are, in fact, framing problems. FIGS. 24 and 25 are temperature profiles of wall internal components of a residential building. In FIG. 24, the thermal anomaly 52 is indicative of a structural misalignment. In FIG. 25, the thermal anomaly 53 is indicative of a structural misalignment. A review of the digital recording of the thermal profile shows an anomaly this is indicative of structure misalignment.

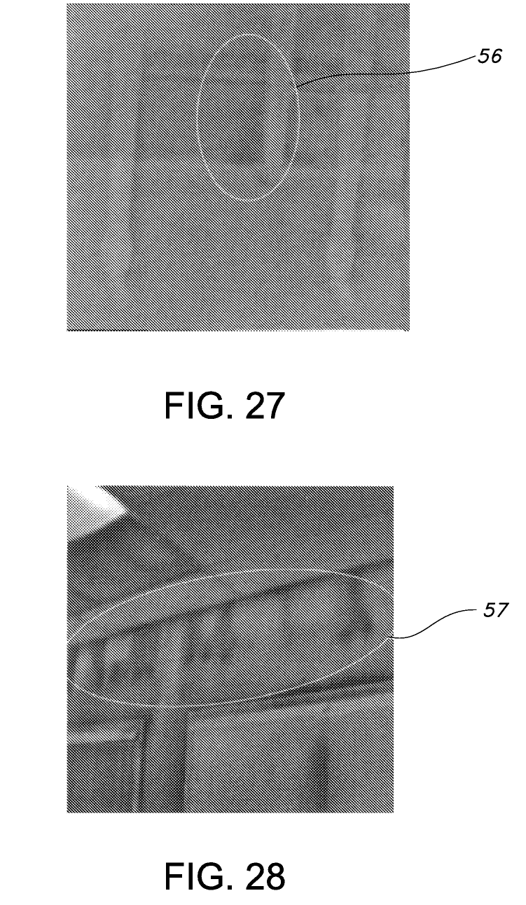

(8) Wood Destroying Insect—Pests such as termites and even mouse and rat infestations have been recorded because of the telltale thermal discrepancies their respective environments provide. In the case of native termite species, these destructive pests require moisture in order to survive at high humidity levels. The thermal imaging system provides an additional tool for discovering the presence of termites and increases the detection of an active colony from about 30% (traditional inspection method) to at least 60%. This means that while the sensor system cannot detect 100% of all termite infestations, it can measurably double the chances of finding active colonies that have not been discovered through traditional inspection. FIGS. 26 and 27 are thermal profiles indicative of suspected termite infestation. More specifically, FIG. 26 shows to thermal anomalies 54 and 55, indicative of suspicious wood destroying insect infestation. Similarly, FIG. 27 shows an anomaly 56 indicative of wood destroying insect infestation. The presence of wood destroying insects can be confirmed by an acoustic scan. The protocol for an acoustic scan is set out in U.S. Pat. No. 7,271,706 filed Oct. 7, 2003.

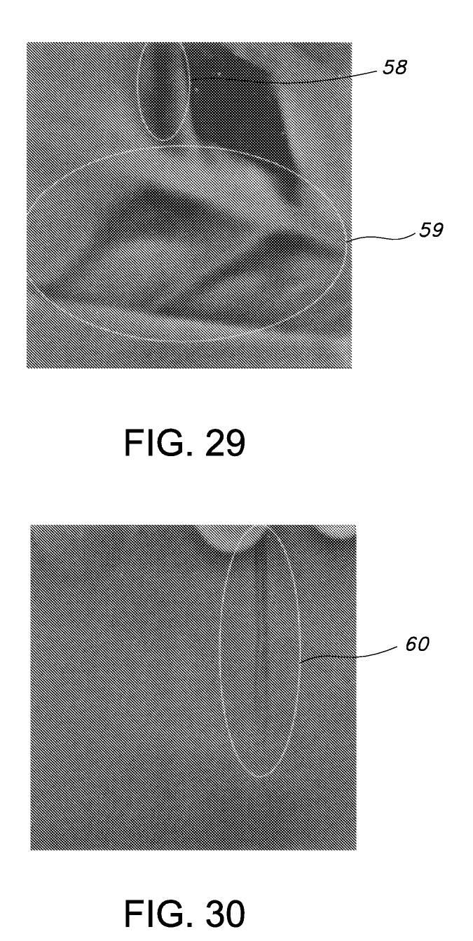

(9) Air Duct Leakage—FIGS. 28 and 29 show a temperature profile indicative of air duct leakage. In these temperature profiles, the anomalies 57, 58 and 59 are indicative of air leaking out of an air duct. The black is cold air leakage in the summer (in the winter it would be opposite).

(10) Inspection of basement wall (water leaks through cracks, pipes, etc.) The application of the present thermal imaging techniques provides the ability to distinguish areas of relative temperature difference. This means that cool areas appear dark relative to warmer areas, which appear lighter. Relative temperature can be seen under these conditions. The first is different thermal characteristics of the building components, the second is actual differences in temperature, and the third is the ability of heat to be removed from the substrate by evaporation. The mere presence of moisture within or exterior to a building component does not guarantee that the thermal camera will show that moisture is present. There has to be a way for evaporation to permit heat loss. Without the ability to evaporate, water will take on the temperature of the substrate, and the equipment will be blind to the presence of the moisture. It should be recalled in order for the camera to distinguish relative differences in temperature, there has to exist a temperature difference of 0.08° C. or greater between residential building components.

Thus, to inspect a basement, if it is necessary, to create air flow to the basement area by: (a) Open heating or cooling air outlet if they are closed (wait for at least 30 minutes before infrared scan); (b) Open all basement doors or windows (wait for at least 30 minutes before Infrared scan); and (c) Create artificial air flow by using portable force air heater (wait for at least 30 minutes before infrared scan).

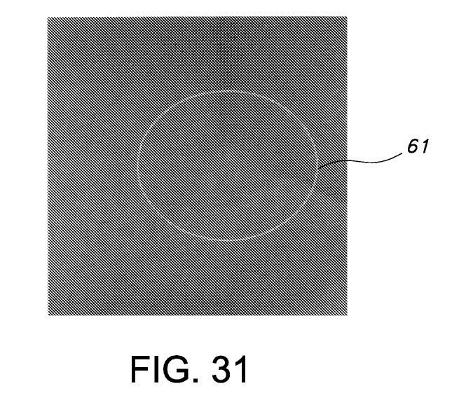

FIGS. 30 and 31 are temperature profiles indicative of moisture penetrating through cracks in a basement wall. More specifically, in FIGS. 30 and 31, anomalies 60 and 61 are indicative of moisture on a basement wall.

The temperature profiles database library is made of a compilation of numerous temperature profiles in different settings, areas and conditions over a period of years. In this regard, the system may be used as an experimental set-up to capture recordings of temperature profiles that can be used as reference patterns for comparison with future captured temperature profile patterns. The temperature profiles database library can also be used as a valuable training tool for training future inspectors. This invention also provides a method for facilitating a computerized method for inspection of a residential building. This method involves maintaining a database of temperature profiles for residential building components at a computerized, centralized facility. The temperature profiles can be input to the computer via a wireless transmission means such as wireless internet connection or by a nonwireless transmission means, such as a disk, a cable and infrared transmission.

An application database management program, such as SAP or Oracle, can be used to set up fields, such as, type of anomaly, normal residential building component, residential building component with an anomaly, and a specific designated residential building. The fields are used to facilitate scanning the database for a selected temperature profile. Thus, if one is interested in, for example, a specific residential building, all temperature profiles relating to a specific house are selected. For example, a specific residential structure can be inspected on a periodic basis, and the temperature profiles can be maintained in a field in the database. These inspections can occur on different days such as three times a year. A printer driver on the hard drive of the computer is used to control a printing device to print a report showing selected temperature profiles of residential building components.

Although the present invention has been described and illustrated with respect to preferred embodiments and a preferred use thereof, it is not to be so limited since modifications and changes can be made therein which are within the full scope of the invention.

1. A method to locate the source of mold growth in a at least one interior building component of a residential building having an interior and an exterior, comprising the steps of:
creating a temperature differential of greater than 10° F. between the interior and the exterior of the residential building and then;
obtaining at least one temperature profile of the at least one interior building component;
assessing said at least one temperature profile for a thermal anomaly indicative of moisture; and
identifying the location in said interior residential building component of said thermal anomaly indicative of moisture.

1. The method of claim 1 further comprising the step of:
sampling said location for a mold sample.

2. The method of claim 2 further comprising the step of testing said mold sample for a mold species.

3. The method of claim 2 further comprising testing of said mold sample for a mold spore level.

4. The method of claim 1 wherein one of said interior residential building component is carpet.
